(19) United States
(12) Patent Application Publication
(10) Pub. No.: US 2011/0115896 A1
(43) Pub. Date: May 19, 2011

(54) HIGH-SPEED AND LARGE-SCALE MICROSCOPE IMAGING

(75) Inventors: Todd C. Doehring, Philadelphia, PA (US); Sankhesh Jhaveri, Clifton Park, NY (US)

(73) Assignee: DREXEL UNIVERSITY, Philadelphia, PA (US)

(21) Appl. No.: 12/950,256

(22) Filed: Nov. 19, 2010

Related U.S. Application Data
(60) Provisional application No. 61/262,630, filed on Nov. 19, 2009.

(51) Int. Cl. G06K 9/36; H04N 7/18

(52) U.S. Cl. 348/79; 382/128; 348/E07.085

(57) ABSTRACT

An imaging system generates an image of a specimen by acquiring images of individual portions of the specimen and combining the images to form a composite image. The system moves the specimen to a set of predetermined locations such that all portions of the specimen are captured into images. At each location, images are heuristically acquired at a different distance from an acquisition lens, and the image with the sharpest focus is selected. The selected images are combined to form a composite image by computing and removing overlapping regions of the adjacent images with sub-pixel spatial accuracy. And, the system is capable of imaging thick specimens with high topological variations.

### CROSS-REFERENCE TO RELATED APPLICATIONS

This application claims the benefit of U.S. Provisional Application No. 61/262,630, filed Nov. 19, 2009, which is hereby incorporated by reference in its entirety herein.

### TECHNICAL FIELD

The technical field generally relates to imaging and more specifically relates to high-speed microscope imaging of large scale specimens.

### BACKGROUND

Multi-scale imaging of the large scale structures of tissues at high resolution can lead to greater understanding of basic structure-function relationships, and potentially to improvements in tissue engineered constructs and micro-repair techniques. High resolution imaging of large scale structures in fresh whole tissue samples is difficult because microscopes are typically designed for small-scale, narrow field imaging of thin, slide-mounted, specimens. For example, typical Achilles tendon cross-section may be 15×10 mm in size, while the microscope field of view (using a 10× objective) is only 3×2 mm. Existing systems for capturing large-scale tissue specimens are limited to bright field imaging of thin specimens and prepared slides, often lack accuracy, require long processing time, and can be prohibitively expensive.

### SUMMARY

Stepper motors are retrofitted with a microscope and a camera to move a specimen in three dimensions. In one embodiment, the specimen is positioned to acquire images of a portion of the specimen. The images are obtained or captured by moving the specimen different distances from the lens of the microscope, and an image with the sharpest focus is heuristically selected from the images via edge detection. The specimen is moved to an adjacent position such that another portion of the specimen is captured, and a focused image is obtained. The process is repeated for each of the remaining portions of the specimen. The focused images are combined to form a composite image of the specimen. According to one embodiment, the focused images capture overlapping regions. The overlapping regions are processed and removed to form a composite image.

In an embodiment, to form a composite image of the specimen, a median filtering operation may be performed on the captured images. Edge detection may be performed on the median filtered images to form edge images. The edge images may be multiplied with threholded images to form a resultant image. The thresholded image may be formed by thresholding the median filtered image using a predetermined threshold value. One or more sub-regions may be selected within the resultant image for feature tracking. The overlapping regions among the images may be determined based on features within the selected sub-regions.

### BRIEF DESCRIPTION OF THE DRAWINGS

The following detailed description of example embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 is a diagram of non-limiting, exemplary systems for generating a composite image.

FIG. 2 is a flow diagram of a non-limiting exemplary process for generating a composite image.

FIG. 3A is a diagram of edge pixel counts at various z-axis positions for six different test samples.

FIG. 3B illustrates an example set of original images and a set of corresponding edge images.

FIG. 4 is a flow diagram of non-limiting, exemplary process for combining a plurality of images to form an image.

FIG. 5 illustrates an example feature tracking process.

FIG. 6 illustrates an example image thresholding process.

FIG. 7 illustrates an example binary multiplication process.

FIG. 8 illustrates an example point selection process.

FIG. 9 illustrates an example point selection process.

FIG. 10 illustrates an example process for combining tile images.

FIG. 11 illustrates an example process for selecting a sub-region.

FIG. 12 is a flow diagram of non-limiting, exemplary process for combining a plurality of images to form a composite image.

### DETAILED DESCRIPTION OF ILLUSTRATIVE EMBODIMENTS

Understanding the complex relationships between micro-structural organization and macro-mechanical function of connective tissues is fundamental to our knowledge of the differences between normal, diseased/injured, and healing tissues. Images of large-scale tissue specimens using polarized light can be highly valuable for revealing tissue structures. Embodiments include a tile-based wide-field imaging system for obtaining such images that uses inexpensive, low precision or high-speed stepper motors coupled with image registration and automatic focusing process to generate precise and seamless image montages. As described herein, expensive high-precision positioning hardware may be replaced by a low-precision stepper motor positioning system, while maintaining sub-pixel accuracy. In addition to X-Y stage control, a Z-axis control is used to maintain focus.

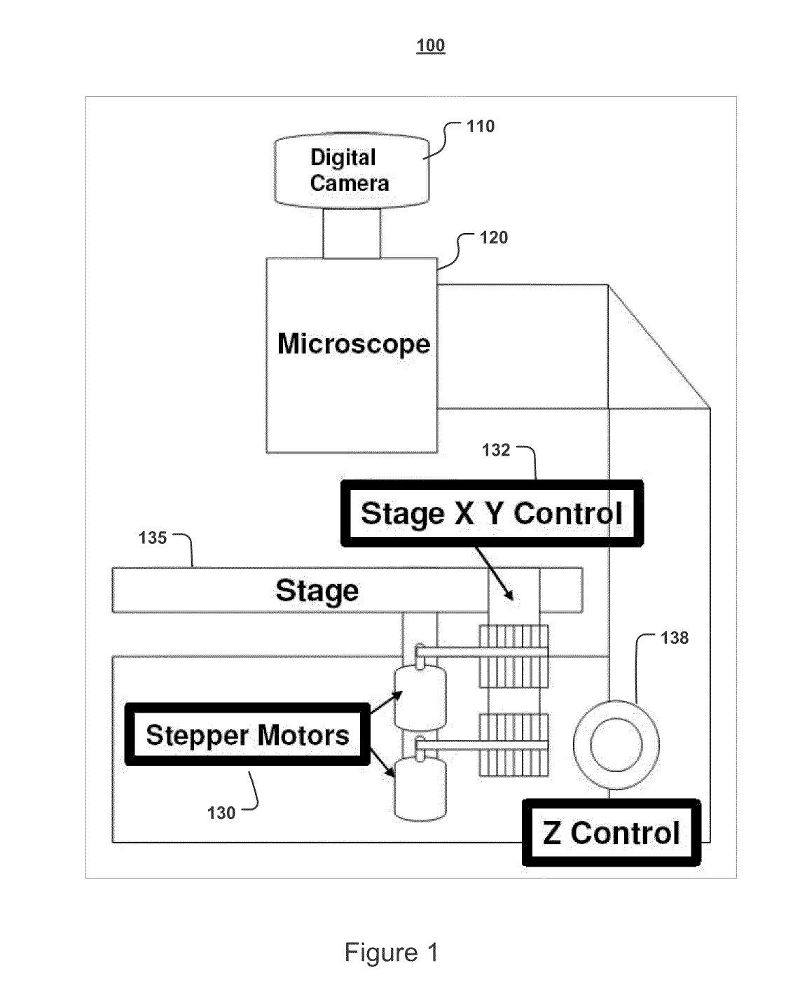

FIG. 1 depicts example systems for acquiring a microscope image of a specimen. As shown in FIG. 1, a camera 110 is placed on a microscope 120. According to one embodiment, the camera 110 can be a commercially available high resolution camera such as 1Ds, Mark II, Canon, Inc. or the like. The camera 110 may have a 16.7 Mpixel full frame, high sensitivity image sensor with maximum resolution of 4992×3328 pixels. The camera 110 is attached to the microscope via a custom-made adaptor, and interfaced with a computing device via an IEEE 1394 (firewire) connection. The microscope 120 can be an upright microscope. For example, the microscope 120 can be a BX50, Olympus, Inc. or the like. According to an example embodiment, the microscope 120 includes a standard X-Y stage 135.

As shown in FIG. 1, stepper motors 130 are retrofitted to the microscope 120. The stepper motor 130 can be representative of any appropriate type of device that can be utilized, for example, to move the specimen to a plurality of positions along all three dimensions. According to an example embodiment, stepper motors 130 are inexpensive, commercially available steppers motors such as NEMA 8, Anaheim Automation, Inc, for example.

In one embodiment, the stepper motors 130 include three stepper motors. A first and second stepper motors are retrofitted with the X-Y stage 135 of the microscope 120 to provide x-axis and y-axis motion control. For example, the x-axis and y-axis are on a plane parallel to an acquisition lens of the microscope 120 and/or the camera 110. A third stepper motor provides z-axis motion control. For example, the z-axis can be orthogonal to the plane that encompasses the x-axis and y-axis. For example, the third stepper motor can be connected to the “fine” focus knob of the microscope 120. The stepper motors can be physically connected to the shafts using timing pulleys and belts. According to an example embodiment, the positioning accuracy of the stage is 40 μm in the x-axis, 80 μm in the y-axis, and 0.1 μm in the z-axis.

According to an example embodiment, the stepper motors 130 is operatively connected to a computing device. For example, a communication component can be provided to facilitate communication between the stepper motors 130 and the computing device. In one embodiment, the stepper motors 130 can be electrically connected to micro-stepping drive modules such as bipolar chopper drives or the like, which can in turn be connected to a computing device via a parallel port interface. The parallel port interface may replace expensive stepper motor controller hardware such that the computing device may directly control multiple motors. In one embodiment, the computing device is used to automate image acquisition, image viewing and image storage.

According to an example embodiment, before acquiring image tiles, the camera may be aligned with the light source and parallel to the X and Y axes of the stage. Calibration images are obtained for each microscope objective that include, but not limited to 4×, 10×, 20×, and 40×, and a number of different light intensity settings. The calibration images are stored for subsequent correction of lens distortion and luminosity variations. According to one embodiment, the calibration images are used to correct color variations.

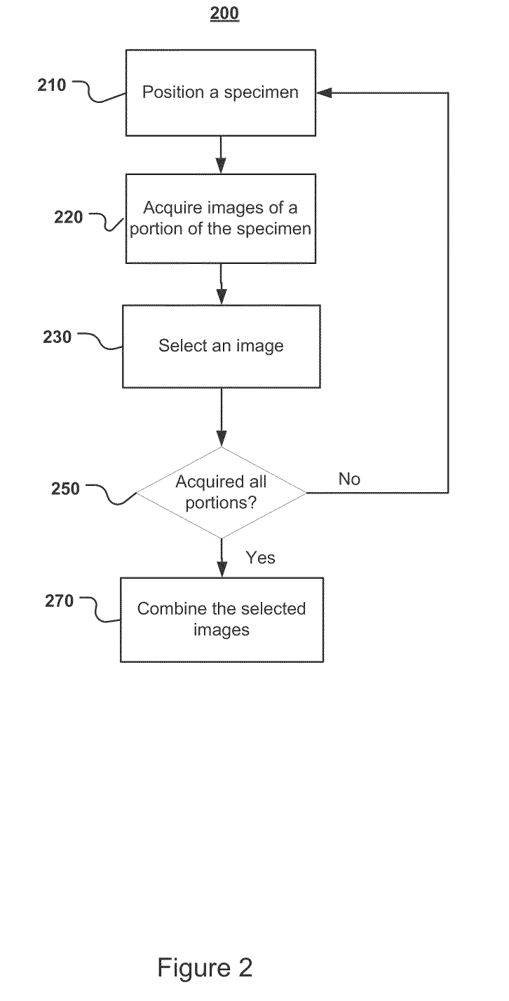

FIG. 2 is a flow diagram of an example process for generating a composite image. According to one embodiment, a composite image of specimen may be generated based a plurality of microscope images. For example, the specimen can be a thick specimen with high topological variation. Process 200 divides the specimen into multiple portions, acquires a focused image for each portion, and combines focused images into one composite image. Accordingly, the process 200 is capable of imaging thick specimens with high topological variations.

As shown, at 210, the specimen may be positioned such that a portion of a specimen may be captured by the camera. For example, as described above, stepper motors 130 as shown in FIG. 1 may move the specimen on a plane parallel to the acquisition lens via a plurality of stepper motors. Specifically, the stage x y control 132 as shown in FIG. 1 may move the specimen to a number of predetermined positions long an x-axis and a y-axis on the plane parallel to the acquisition lens. According to one embodiment, the stepper motors may move an acquisition lens of the microscope and/or the camera to capture various portions of the specimen.

At 220, a predetermined number of images of a portion of the specimen may be captured at different distances from an acquisition lens. As described above, the specimen may be moved to a number of predetermined positions along an x-axis and a y-axis on a plane parallel to the acquisition lens, such as X-Y stage 135 as shown in FIG. 1. To capture images at different distances from the acquisition lens, the specimen may be moved along a direction orthogonal to the plane parallel to the acquisition lens, for example, via Z control 138 as shown in FIG. 1.

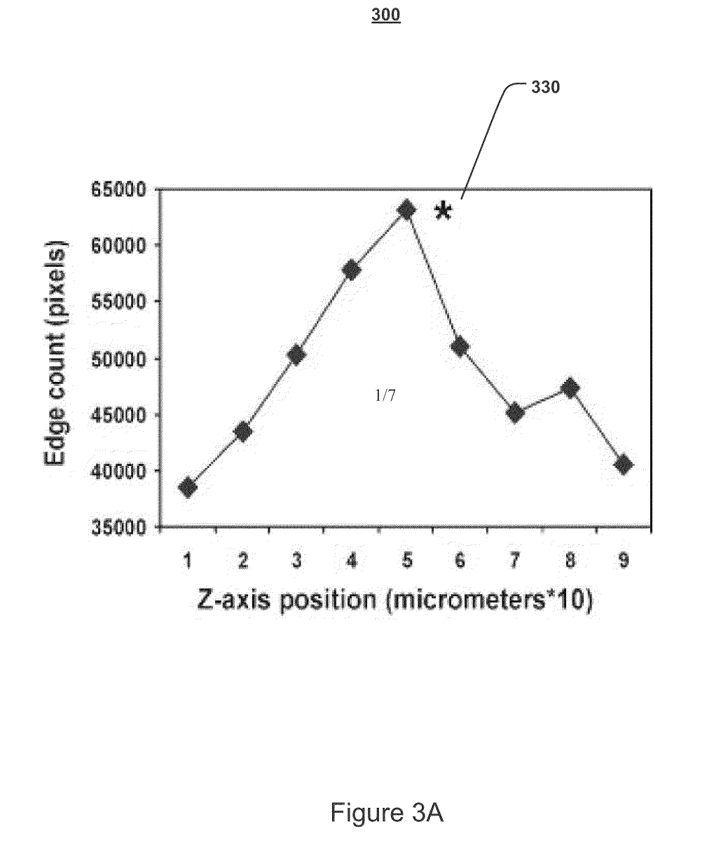

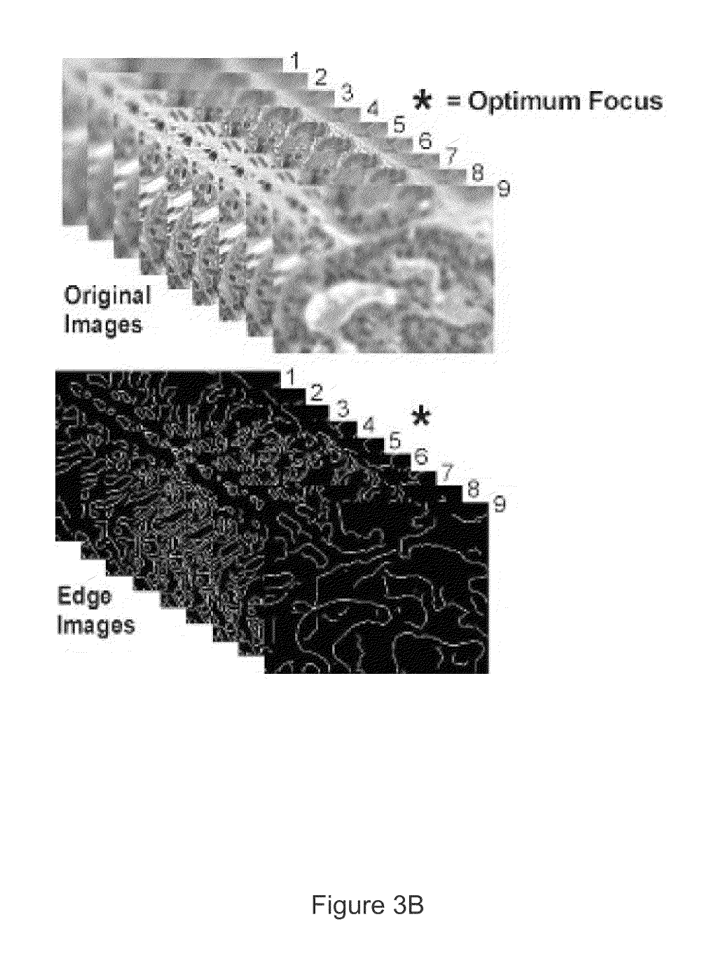

At 230, one of the images may be selected in accordance with an optical parameter. According to one embodiment, an image with the sharpest focus may be selected. For example, edge detection may be applied to the images acquired at 230. A set of edge images with white pixels representing edges and zero otherwise may be generated. FIG. 3B illustrates a set of original images and a set of corresponding edge images. The sum of white pixels may be counted for in each of the edge images. For example, the image that contains the highest number of white pixels may contain the most edges. The higher number of edges may indicate sharper focus. The image that corresponds to the edge image with the highest number of white pixels may be identified as the image with the sharpest focus. Next, the range surrounding the z-axis position of the tile image with the sharpest focus may be subdivided in a number of z-axis positions. A new set of tile images may be acquired at the subdivided z-axis positions. The above steps may be repeated until a maximum edge pixel count is reached.

FIG. 3A is a diagram of edge pixel counts at various z-axis positions for six different test samples. By way of example, a series of nine images (10× magnification) may be acquired at nine z-axis increments. Edge images may be generated, edge pixel counts may be computed, and a corresponding plot of the edge pixel counts may be made as shown in FIG. 3A. The peak edge count 330 may be the position of optimal focus. The peak value corresponds to the optimally focused image. The highest edge image pixel count may correspond to the optimally focused image. The position that corresponds to the peak edge count may be considered to be the position of optimal focus.

Turning back to FIG. 2, at 250, whether all portions of the specimen have been acquired may be determined. According to one embodiment, the specimen may be moved to a number of predetermined positions along an x-axis or a y-axis on a plane parallel to the acquisition lens, such that all portions of the specimen may be captured into images. The specimen may be repositioned to acquire images of a contiguous portion of the specimen. In one embodiment, two contiguous portions may overlap. For example, the specimen may be moved to an adjacent position along an x-axis or a y-axis on a plane parallel to the acquisition lens to acquire images of the contiguous portion. Thereafter, the specimen may be moved to another adjacent position to capture another contiguous portion of the specimen until all portions are captured. If at 250, it is determined that not all portions have been acquired, the specimen steps 210-250 may be repeated. When it is determined that images of all portions of the specimen have been acquired, at 270, the selected images may be combined to form a composite image of the specimen as will be described in more details hereinafter.

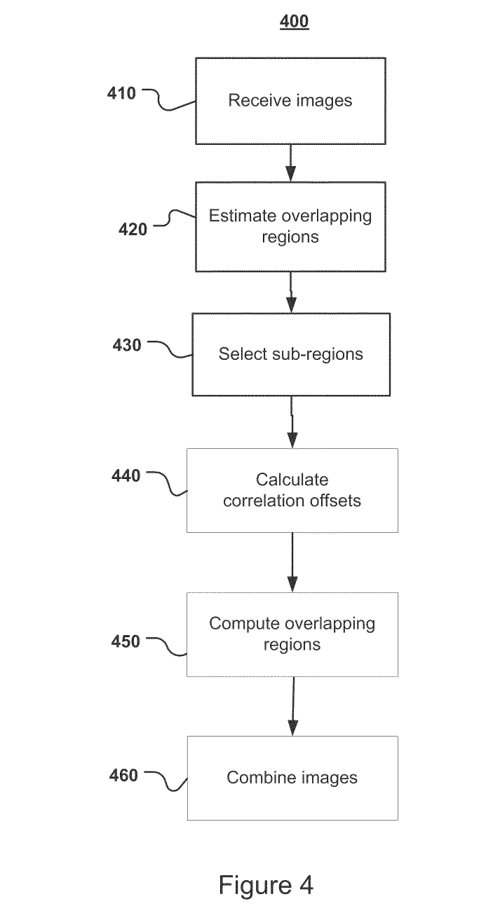

FIG. 4 is a flow diagram of an example process for combining a plurality of tile images to form a composite image. Process 400 is a non-limiting, exemplary process that uses a tile registration algorithm to enforce sub-pixel accuracy of image tile alignment. According to one embodiment, the process 400 may enforce precise image tile color matching.

As shown in FIG. 4, at 410, images may be received. As described above, tile images or image montages of portions of a specimen may be acquired by positioning the specimen in a number of locations. The tile images may be stored on a computer-readable storage medium. According to one embodiment, tile images may be received from a computer-readable storage medium.

At 420, an overlapping region may be estimated. As described above, each portion may overlap a contiguous portion of the specimen, and accordingly, each tile image may overlap a contiguous image. To reconstruct the full montage, or composite image, the image tiles may be aligned by removing overlapping regions based on digital image correlation. Initially, the precise overlapping region may be unknown because high-speed stepper motor stage control may cause positioning errors, for example, up to 80 μm. For example, overlapping regions may be estimated based on coarse stepper motor positions.

At 430, sub-regions in the estimated overlapping regions may be selected. For example, a grid of 2×10 sub-regions of pixel windows in each estimated overlapping region may be selected. A pixel window may include a window of, for example, 20×20 pixels. According to one example, each window may span approximately 40 μm. In an embodiment, a point within the sub-region or window may be selected. The point may be at the center of the sub-region or window. The sub-regions may be randomly selected. The sub-regions may also be selected based on the quantity or quality of feature(s) contained therein.

In an embodiment, high feature content may be identified from the overlapping regions. A histology image may consist of different kinds of tissue and cellular structures. Parts of the image can be empty regions that may contain little or no information. For example, a large empty vacuole may show up as a blank region in an image providing little information for feature tracking. For example, it is possible that the vacuole may occupy some portion of the overlapping region. If the vacuole lies in the overlapping region between two tile images, the vacuole or white space may cover the overlap entirely or may cover a portion of the overlapping region. The white space may be discarded while selecting windows for feature tracking

As described above, one or more sub-regions may be selected for each pair of overlapping regions. The selected sub-regions may include a window that may provide an accurate offset between two overlapping regions. For example, a selected sub-region may include a window has a large number of features in the form of high spatial frequency content or high texture content. The system of equations for minimization of residual error in the offset calculation may be solved reliably.

Sub-regions that may provide an accurate offset between two overlapping regions may be identified via edge detection. For example, an edge detection algorithm developed by Canny, Harris edge detector SUSAN corner detector, and/or any other edge detection algorithm may be used. In an embodiment, the edge points may be localized. For example, the distance between the points marked by the detector and “the center” of the true edge may be minimized. To prevent multiple responses to a single edge, operators may be derived using a numerical optimization for determining and identifying edges.

Image noise may be taken into account during edge detection. For example, common noise encountered in image data may be isolated noise. Isolated noise may be more prevalent in image regions that lack foreground data such as cellular structures in histology images. In an embodiment, isolated noise may be removed or reduced.

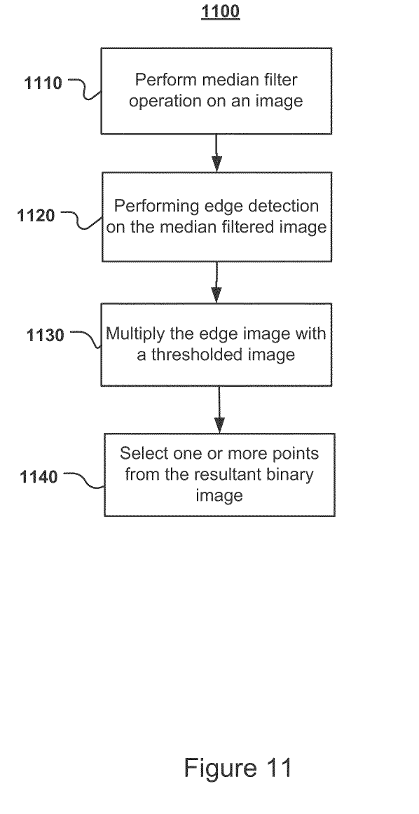

FIG. 11 illustrates an example process for selecting a sub-region. This process may also be referred to as point selection hereinafter. At 1110, a median filtering operation may be performed on a tile image or on an estimated overlapping region of a tile image. A white space region may include a range of intensity values. Though the range may be small enough to classify the region as a white space, the variations may be large enough for the edge detection to identify these intensity differences as potential edges. This may result in faulty edge detection. To prevent faulty edge detection, a median filtering operation may be performed on the image to remove isolated intensity variations prior to edge detection.

A median filter may include a canonical image processing operation. For example, let [xᵢⱼ] be the matrix representing a digitized image. The result of the median filtering operation with an m×n, where m, n are odd integers, window may include an image [yᵢⱼ] where yᵢⱼ may equal to the median of the gray levels of the picture elements lying in an m×n window centered at the picture element xᵢⱼ in the input image. A brute force algorithm for median filtering may build a list of the pixel values in the filter window and sorts them. The median may include the value situated at the middle of the list. This median may be placed at the center of the window to eliminate the abrupt change in intensity at the center. Median filtering may result in a clean image with few to no isolated intensity variations.

As shown in FIG. 11, at 1120, the median filtered image may be sent for edge detection. The output of the edge detection may be an edge image. An edge image may include a binary image containing white edges in a black background, or black edges in a white background.

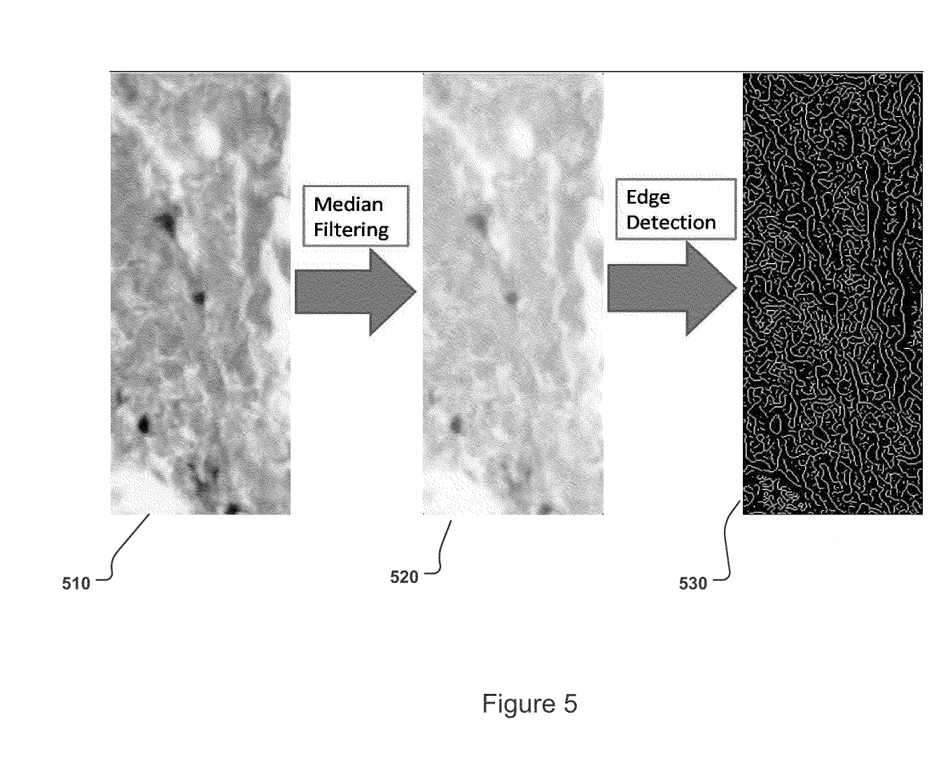

FIG. 5 illustrates an example feature tracking process. As shown in FIG. 5, image 510 may be an image of overlapping region from one of a pair of tile images to be stitched. For example, image 510 may include an overlapping region from one of the images of a tile array of a breast biopsy histology slide. Image 520 may be a median filtered image. Image 520 may be passed through an edge detection operation. Image 530 may be a binary image obtained after edge detection on the median filtered image depicting white edges in a black background.

Turning back to FIG. 11, at 1130, the edge image may be multiplied with a thresholded image via binary multiplication. In an embodiment, only edges that define features in the image may be sent for point selection. For example, an edge image may include edges from every part of the image including the parts that may not contain a trackable feature. To reduce or remove edges that may not include trackable features, the edge image may be multiplied with another binary image using binary multiplication. In an embodiment, after the edge image is multiplied with the binary image, the resultant image may include edges from the information-rich areas of the original image.

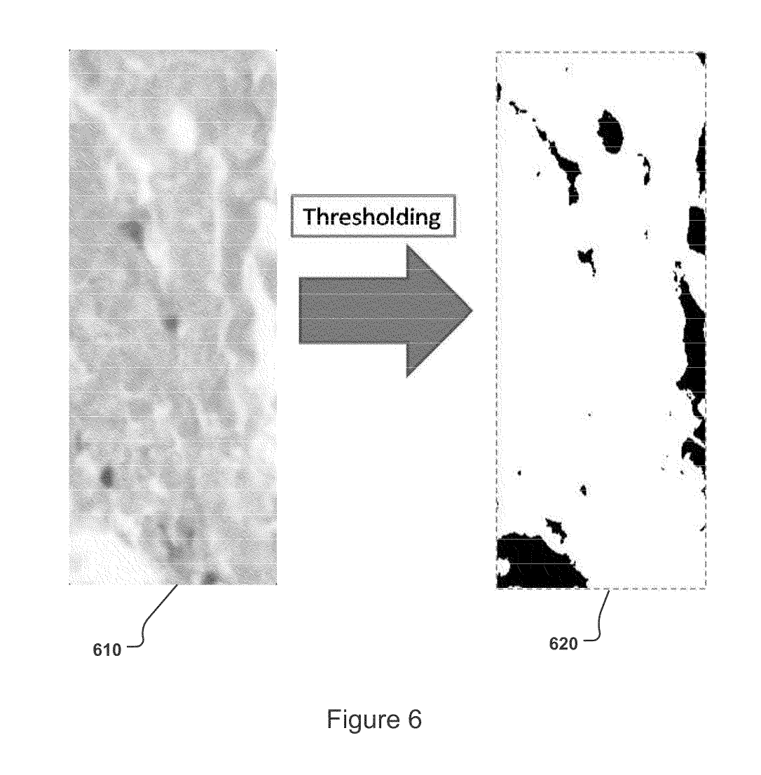

The binary image to multiply the edge image with may be obtained via thresholding of the original image. FIG. 6 illustrates an example thresholding process. As shown, image 610 may be an image of overlapping region from one of a pair of tiles to be stitched. For example, the image 610 may be a median filtered image. Image 620 may be a binary image obtained after thresholding of the median filtered image. For example, the threshold value may be selected such that, in the binary image, the white spaces from the original image may be represented as black areas (e.g. digital 0) and the other information may be represented as white (e.g. digital 1). For example, the threshold value may be selected such that, in the binary image, the white spaces from the original image may be represented as white (e.g. digital 1) and the other information may be represented as black areas (e.g. digital 0). The threshold value may be chosen such that the binary image may have an intensity of ‘0’ at the white spaces.

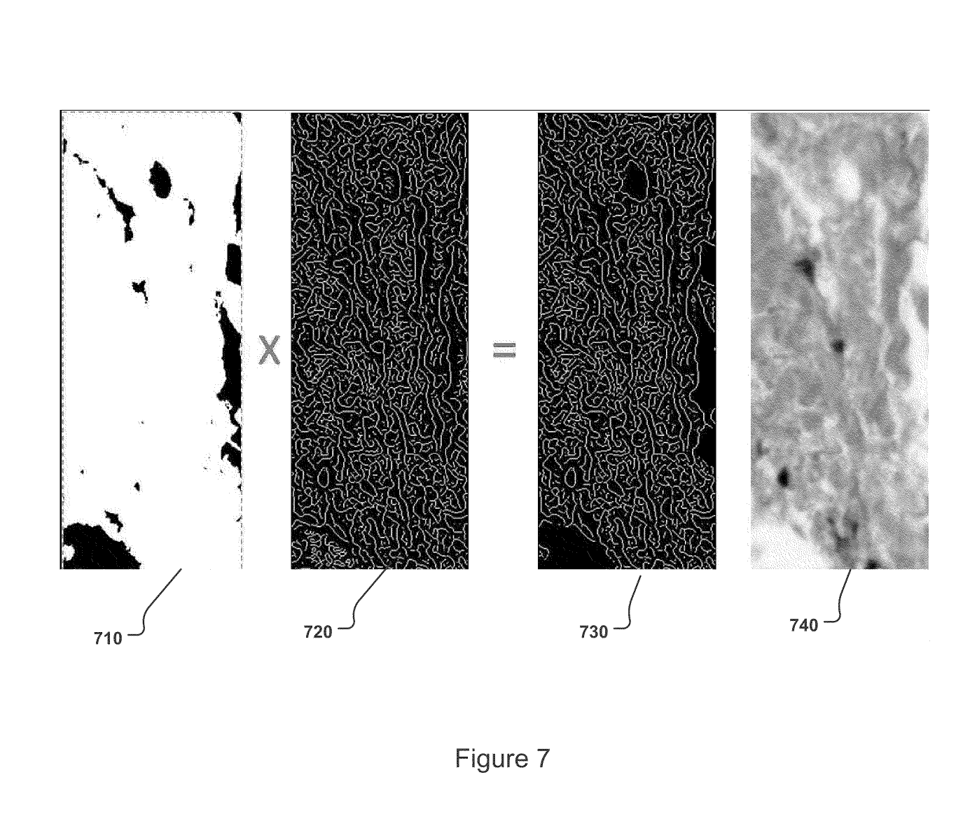

FIG. 7 illustrates an example binary multiplication process. Image 710 may be a thresholded image, and image 720 may be an edge image. By multiplying the thresholded image 710 with the edge image 720, image 730 that may be devoid of edges in white spaces may be produced. Image 740 may be the original image of the overlapping region. As shown, white spaces in image 740 are represented as black areas in image 730.

Turning back to FIG. 11, at 1140, one or more points may be selected from the resultant binary image. The resultant image obtained after median filtering, edge detection and binary multiplication may contain edges that represent features in the overlapping region image. The image may be used to select points around these features. The selected points may define feature windows that may be used by the tracking algorithm to correlate the two images. For example, points may be selected such that a 20×20 pixel window around the point may contain the largest number of edges in that image. This is to ensure that the windows used for tracking are rich in features for an optimum correlation. In an embodiment, the edge image may be cropped by at least 25, 30, 35 pixels or the like on each boundary. This may reduce the risk of selecting points at the boundary of the overlapping region.

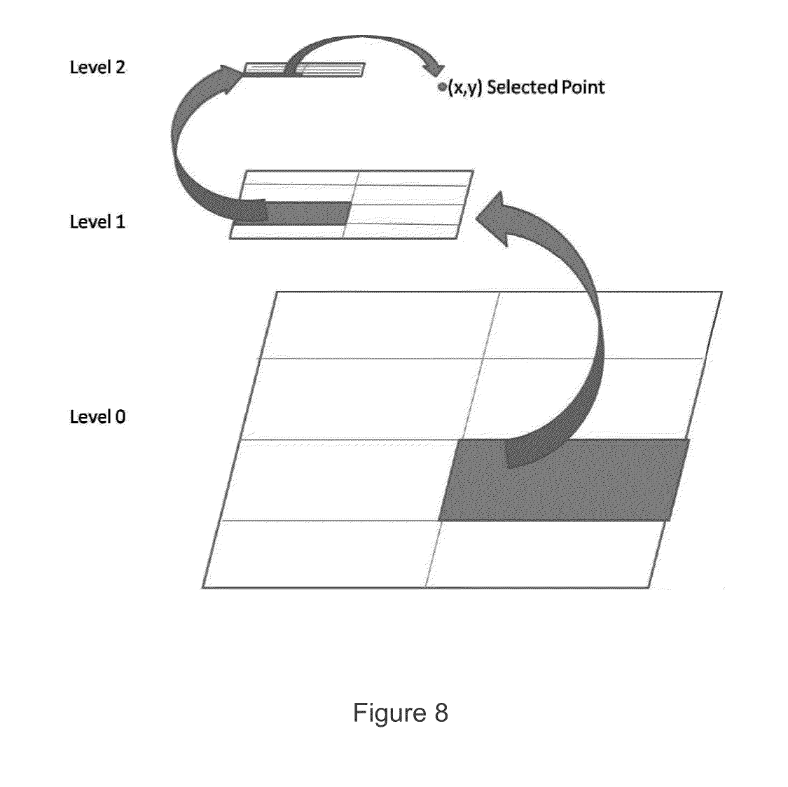

FIG. 8 illustrates an example point selection process. The edge image may be repeatedly divided into several divisions based on the number of edges in each sub-division. For example, once the sub-divisions obtained after repeated division reaches a predetermined size, such as 20×20 pixels or the like in size, a point may be selected. The selected point may be sent for feature tracking to correlate the images based on a 20×20 pixel window around the point.

In an embodiment, the process for point selection from a binary image may include the follows:

1. Divide the whole image in a specified number of divisions (e.g. level 0 in FIG. 8).

2. Calculate the total number of edges in each division. This may be done using a simple summing algorithm for a binary image.

3. Sort the division indices in descending order of the number of edges in each division.

4. Take the first division in the list and repeat steps 1 to 3 dividing the first division into the specified number of sub-divisions (e.g. level 0 in FIG. 8).

5. Repeat step 4 to obtain further sub-divisions (e.g. level 0 in FIG. 8).

6. Take the first division from the sorted list and save the center of the division in the final list of points.

7. Make the entire level 2 sub-division black such as digital 0 in the level 0 division.

8. Repeat steps 1-7. This iteration may be performed multiple times, such as 3 times, to select different points.

In an embodiment, once the points are selected, the list of points may be fed as a vector to a feature tracking process for calculation of the X-Y offset between the two overlapping regions.

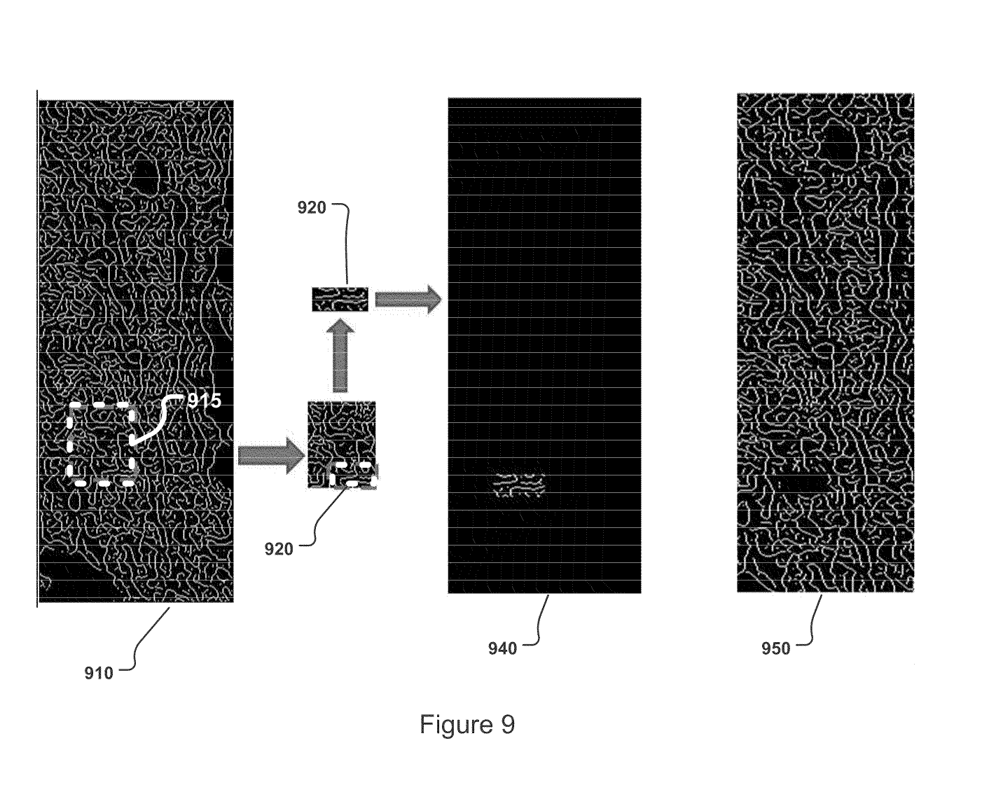

FIG. 9 illustrates an example sub-region selection or point selection process. Image 910 that may be an edge image obtained after binary multiplication may be divided into 10 divisions. The division with the largest number of edges, for example, division 915, may be selected. The division 915 may further sub-divided into a predetermined number of sub-divisions such as 10 sub-divisions. The sub-division with the largest number of edges, such as sub-division 920, may be used to select a point. The image 910 may be blacked-out leaving the sub-division of interest, sub-division 920, to form image 940 for maintaining the index of the selected region. Image 950 may be an image resulted from subtracting the image 920 from the image 910. The image 950 may be sent through the point selection process for selection of a next point.

In an embodiment, the specimen may be pre-scanned. Pre-scanning may generate a primitive image of the entire specimen from the image tiles. The pre-scan image may include an elementary version of the final image. The pre-scan image may provide information about the final image that otherwise would not be available prior to combining the image tiles. Using the pre-scan image, the regions in the final image where white space occupies a substantial area at the seam may be identified. These may be the regions likely to encounter errors and throw the image combining process off-course while stitching the final image. Identifying error-generating regions in advance may prevent the image combining process from failing.

For example, pre-scanning process may include, but not limited to, the following steps:

1. Down-sample the image tiles. For example, the image tiles maybe down-sampled to 30%, 40% or 50% of their original size.

2. Crop the tiles using overlap estimates. The overlap estimates may be provided by the user.

3. Create a blank image of the size of the final stitched image from the down-sampled tiles. The stitched image may have nᵣ×r number of rows and n_{c}×c number of columns for a nᵣ×n, size array of r×c sized down-sampled tiles.

4. The tiles may be superimposed on the blank image in accordance with their respective indices in the tile array.

5. The seams of the pre-scan image may be extracted in another image. This image may contain only the seams and the surrounding overlap regions of the tiles.

6. Global edge detection may be performed on the image containing seams using an edge detection algorithm.

7. Seams containing less than a predetermined threshold number of edges may be considered to have a significant amount of white space.

8. The indices of these tiles that were found to contain a significant amount of white spaces in step 7 may be saved in a matrix to be passed onto a stitching process that may combine the tile images.

In an embodiment, the indices passed onto the image combining process from the pre-scanning process, may be used to identify overlapping regions in the tile array with considerable amount of white spaces. Thus, complex computational analyses to circumvent the problem of tracking feature-less white space may not be required.

Turning back to FIG. 4, at 440, correlation offsets may be calculated. According to one embodiment, a correlation offset may include an X-Y offset of a maximum correlation. For example, a correlation coefficient may be identified for each sub-region selected at 430. Correlation coefficients may be calculated by comparing sub-regions in the estimated overlapping region and identifying correlations. In one embodiment, a correlation may be identified when the maximum correlation value higher than 0.98. For example, the offsets may be used to correct the positioning error caused by low-precision stepper motors.

By way of example, 20 sub-regions may be selected at 430, and twenty respective correlation offsets may be calculated at step 440. The 20 offsets may be sorted, the mean offset may be identified, and the standard deviation may be calculated. According to one embodiment, whether the calculated correlation offsets are similar may be determined. In one embodiment, the offsets may be determined to be similar if the standard deviation of the offsets is within a predetermined value. For example, the predetermined value may be 0.2 pixel, 0.5 pixel, 0.7 pixel, 1 pixel or the like. According to another embodiment, the standard deviation of a subset of the calculated offsets, for example, the three most similar offsets, may be compared against the predetermined value to determine whether the positioning error offsets are similar. If the offsets are determined to be similar, the offsets may be applied to compute overlapping regions between tile images. If the determination is that the correlation offsets are not similar, then steps 420-440 may be repeated with a new set of sub-regions until a set of similar offsets are identified. According to one embodiment, if similar offsets cannot be identified in the estimated overlapping region after a predetermined number of iterations, the system displays a warning to the user. The user can then adjust settings to improve the result, and restart the process 400.

According to one embodiment, an image tile registration vector may be generated. For example, because the X-Y stage motion is body translation highly correlated image registration points should have the same registration vector. In one embodiment, a predetermined number of correlated points may be required to have the same registration vector within a predetermined standard deviation such as 0.5 pixels. For example, when three strongly correlated points in an estimated overlapping region have the same X-Y registration vector, the registration vector may be used to compute the overlapping regions.

At 450, overlapping regions may be computed. According to one embodiment, the computed overlapping regions may be more precise than the estimated overlapping regions. In one embodiment, overlapping regions may be computed based on the correlation offsets calculated at 440. According to one embodiment, the location of the seam that adjoins the image tiles may be computed.

According to one embodiment, steps 410-450 may be applied and/or repeated to stitch a row of tile images, for example. After each row is stitched together, then the rows may be joined into the full image by repeating steps 410-450. The end result may be a full reconstruction where the errors in fast stepper motor positioning may be corrected, and image tiles may be registered with sub-pixel accuracy. The twenty sub-regions in the initial grid may be used to account for the possibility of blank regions in the specimen where no correlation is possible. If no correlations are found for three iterations of twenty pixel windows, then the program may calculate and apply the mean offset from the two adjacent rows. This may account for the possibility of blank regions within the slide/specimen. According to one embodiment, blank regions are managed by analyzing the remaining whole image reconstruction and using information from surrounding areas to refine the blank tile placement.

In an embodiment, when an overlapping region that may have little or no variations in pixel intensities, e.g., a white space, is encountered, the process may return an error and come to a complete halt.

In an embodiment, when an overlapping region that may have little or no variations in pixel intensities is encountered, the offset information from the preceding row for that column and stitch the corresponding row may be used. For example, the width of the overlapping region may be approximately the same in succeeding rows. As a result, the offset output of the feature-tracking process may approximately be the same for succeeding rows. Therefore, if there is a large white space that cannot be correlated with the tracking algorithm, the width of the overlapping region may be approximately the same in succeeding and/or preceding rows may be used. In an embodiment, combining the tile images may be performed after the X-Y offset for all tiles is calculated. The offset for each pair of consecutive tiles may be calculated and stored it in a matrix according to the index of the pair of tiles. This matrix may then be referred to when combining the tile images.

When an overlapping region containing a significant amount of white spaces is encountered, the tile may be flagged by storing the index of the tile in a matrix such as white space matrix. The white space matrix may include the indices of tiles containing a significant amount of white spaces, and may be then passed to the tile combination process. When tile combination process reaches one of the tiles whose index is in the matrix relayed by the pre-scanning algorithm, the offset calculation for that particular tile may be skipped. The offset for that specific tile may be marked as ‘−1’ or any other identifier for the flagged tiles. When the command is transferred to the function that calculates the seam, crops and places the tiles in a single row, it may refer to the matrix of the offsets. When the process encounters a ‘−1’ in the offset matrix at a particular location, the process places the offset of the same column from the preceding or succeeding row at that location. For example, if there is a ‘−1’ in the first row, the value of the same column from the second row may be used. The stitching algorithm then takes the offset and accordingly calculates the seam. This saves time by not sending images that may not contain enough information for feature tracking

The tile combination process may be implemented in a stitching program. The stitch program may be is a dynamic program and may handle the tile images as well as the final stitched image at once during runtime. To perform computations on both, the tile images and the large image during program runtime, they have to be stored in the random access memory (RAM). Consequently, a substantial amount of dynamic memory may be required to hold large tile image data. A single high resolution tile image obtained from the microscope is 400-750 kilobytes in size, approximately. Stitching 49 (a 7×7 image tile array) images may require 20 gigabytes of RAM. For imaging a 10 mm×10 mm area on a histology slide, at 20× magnification, a tile array structure of at least 10×10 image tiles is required. Reconstruction of the imaging may require considerable memory.

In an embodiment, the workload on the RAM may be split into different parts. For example, parallel computing may be performed. The tile combination process may stitch different sections of the image at the same time in an organized manner. The sections may be combined using the same stitching process. Parallel computing can help reduce the time required for the program to run. The use of 8 cores can reduce the time consumption by 8 times.

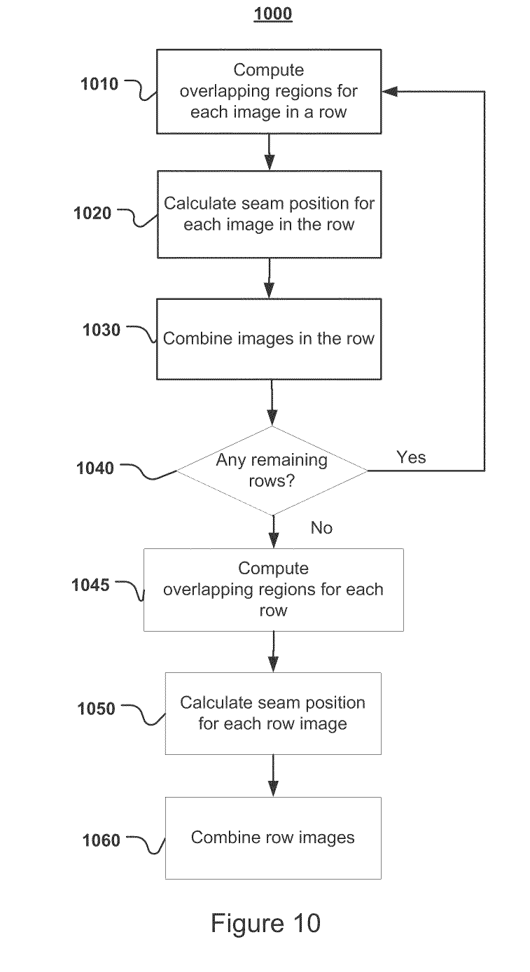

FIG. 10 illustrates an example process for combining tile images. In an embodiment, a row of tile images may be stitched at a time. As shown, at 1010, overlapping regions for each pair of adjacent tile images may be determined. The offsets for each pair of overlapping regions may be determined and an offset matrix may be formed. The offset matrix may be adjusted using information received via pre-scanning for regions with white spaces. At 1020, the seam position for each tile image in the row may be calculated. At 1030, the tile images in the row may be combined or reconstructed. At 1040, if any row(s) of images remain, the steps above may be repeated to combine tile images in each of the remaining rows. Each stitched row may be saved in a cell array as per its row index in the tile array. At 1045, once the rows are stitched, overlapping regions for each row image may be determined. Each pair of adjacent rows may be loaded one by one to determine the X-Y offset between the rows. At 1050, the seam position as per the determined offset may be determined. The row images may be cropped based on the determined offsets. The cropped row images may be stored as individual images. Images may be named in a sequential manner to reference the row index. At 1060, the row images may be combined. A montage display algorithm may be used to display all the rows together as one image. The composite image may be displayed in a single figure window. The composite image may be saved as the final combined/stitched image.

According to an embodiment, process 400 may be tailored to the microscope hardware specifications of the system such that the composite image is reconstructed with guaranteed quantitative sub-pixel spatial accuracy.

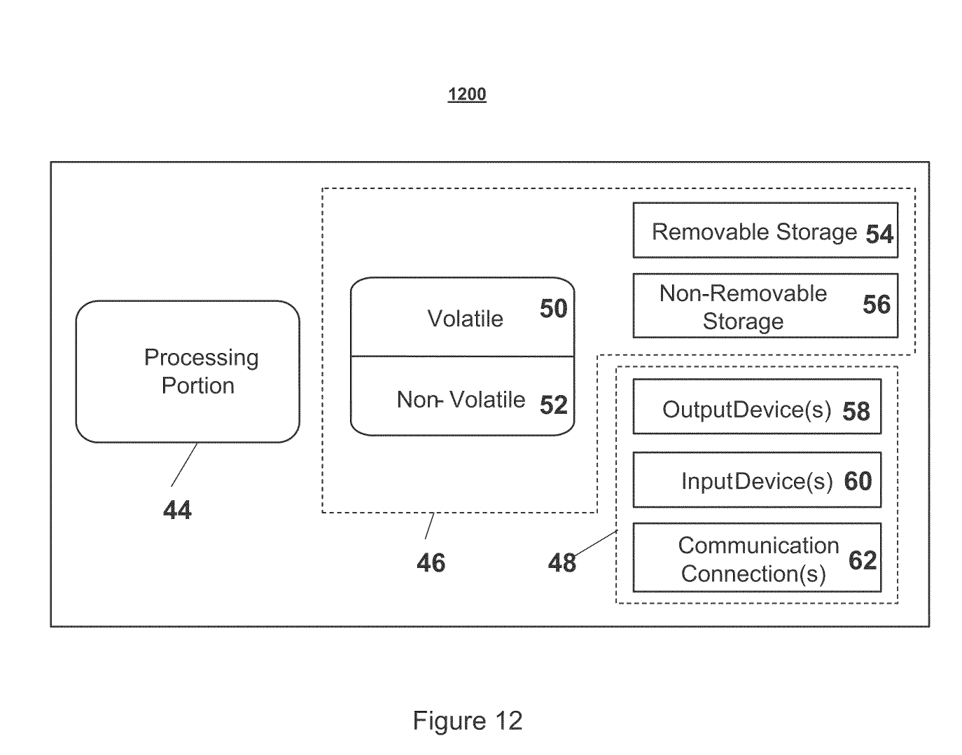

FIG. 12 is a block diagram of an example computing device 42 for acquiring a microscope image of a specimen. In an example configuration, the computing device 42 comprises various appropriate components of the system microscope imaging system. It is emphasized that the block diagram depicted in FIG. 12 is exemplary and not intended to imply a specific implementation. Thus, the computing device 42 can be implemented in a single processor or multiple processors. Multiple processors can be distributed or centrally located. Multiple processors can communicate wirelessly, via hard wire, or a combination thereof.

The computing device 42 comprises a processing portion 44, a memory portion 46, and an input/output portion 48. The processing portion 44, memory portion 46, and input/output portion 48 are operatively connected. The input/output portion 48 is capable of providing and/or receiving components utilized acquiring microscope images as described above. For example, as described above, the input/output portion 48 is capable of receiving the plurality of images, and outputting a composite image generated based on the plurality of images. The processing portion 44 is capable of positioning a specimen to acquire an image of a first portion of a plurality portions of the specimen, wherein, each portion of the plurality of portions overlaps a contiguous portion of the specimen; acquiring a plurality of images of the first portion, wherein the each image of the plurality of images is heuristically acquired at a different distance from an acquisition lens; selecting an image from the plurality of images in accordance with an optical parameter; repositioning the specimen, performing the acquiring, and performing the selecting of respective images for each of the remaining plurality of portions of the specimen; combining the plurality of selected images to form the composite image; receiving the plurality of images, each of the plurality of images capturing a portion of a plurality portions of an object, each portion of the plurality of portions overlaps a contiguous portion of the specimen, each of the plurality of images overlaps a contiguous image; computing a plurality of overlapping regions, each overlapping region is computed for each of the plurality of images and a respective contiguous image; combining the plurality of images based on the plurality of overlapping regions form the composite image, or a combination thereof.

The computing device 42 can be implemented as a client processor and/or a server processor. In a basic configuration, the computing device 42 can include at least one processing portion 44 and memory portion 46. The memory portion 46 can store any information utilized in conjunction with acquiring a microscope image of a specimen. For example, as described above, the memory portion 46 is capable of storing a plurality of tile images, and storing store programming for execution on the processing portion. Depending upon the exact configuration and type of processor, the memory portion 46 can be volatile (such as RAM) 50, non-volatile (such as ROM, flash memory, etc.) 52, or a combination thereof. The computing device 42 can have additional features/functionality. For example, the computing device 42 can include additional storage (removable storage 54 and/or non-removable storage 56) including, but not limited to, magnetic or optical disks, tape, flash, smart cards or a combination thereof. The memory portion 46 can include volatile and nonvolatile, removable and non-removable media implemented in any method or technology for storage of information such as computer readable instructions, data structures, program modules, or other data. the memory portion 46 may include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processing portion 44. Any such computer storage media can be part of the processing portion 44.

The computing device 42 also can contain communications connection(s) 62 that allow the computing device 42 to communicate with other devices, for example. Communications connection(s) 62 can be connected to communication media. Communication media typically embody computer readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The computing device 42 also can have input device(s) 60 such as keyboard, mouse, pen, voice input device, touch input device, etc. Output device(s) 58 such as a display, speakers, printer, etc. also can be included.

What is claimed:

1. A method for generating a composite image, the method comprising:
positioning a specimen to capture a plurality of images of a first portion of a plurality of portions of the specimen, wherein, each portion of the plurality of portions overlaps a contiguous portion of the plurality of portions;
acquiring the plurality of images of the first portion, wherein the each image of the plurality of images is acquired at a different distance, within a range of distances, from an acquisition lens;
heuristically selecting an image from the plurality of images in accordance with an optical parameter;
repositioning the specimen, performing the acquiring, and performing the selecting of respective images for each of the remaining plurality of portions of the specimen to obtain a plurality of selected images; and
combining the plurality of selected images to form the composite image.

2. The method of claim 1, wherein the range of distances covers a full potential focal range for imaging a respective portion.

3. The method of claim 1, wherein positioning the specimen comprises:
moving the specimen on a plane parallel to the acquisition lens via a plurality of stepper motors.

4. The method of claim 3, wherein acquiring a plurality of images comprises:
moving the specimen along a direction orthogonal to the plane parallel to the acquisition lens via one of said plurality of stepper motors.

5. The method of claim 3, wherein the stepper motors are low-precision stepper motors.

6. The method of claim 3, wherein the stepper motors are high-speed stepper motors.

7. The method of claim 1, further comprising:
capturing a calibration image of the acquisition lens; and
reducing lens distortion in the plurality of selected images based on the calibration image.

8. The method of claim 1, further comprising:
capturing a plurality of calibration images of the acquisition lens, respectively under different light intensity settings; and
reducing light luminosity variation in the plurality of selected images based on the plurality of calibration images.

9. The method of claim 1, wherein heuristically selecting an image from a plurality of images of a portion of the specimen comprises:
converting each image of the plurality of images to a pixel representation of each image, wherein edge pixels represent edges of a respective image; and
identifying a first image with a most edge pixels.

10. The method of claim 9, further comprising:
determining a plurality of finer distances nearby a distance of the first image with the most edge pixels; and
acquiring a second plurality of images at the plurality of finer distances;
converting the second plurality of images to images with edge pixels representing edges; and
identifying a second image with the most edge pixels wherein the second image has more edge pixels than the first image.

11. The method of claim 1, wherein combining the plurality of selected images to form the composite image further comprising:
computing a plurality of overlapping regions, each overlapping region is computed for each of the plurality of images and a respective contiguous image; and
combining the plurality of images based on the plurality of overlapping regions form the composite image.

12. The method of claim 11, wherein computing a plurality of overlapping regions further comprising:
estimating an overlapping region for each of the plurality of images and a respective contiguous image;
selecting a plurality of sub-regions within the estimated overlapping region; and
computing a plurality of correlation offsets, each of the plurality of correlation offsets is calculated for a respective sub-region.

13. The method of claim 12, wherein computing a plurality of overlapping regions further comprising:
calculating a standard deviation of the plurality of correlation offsets;
comparing the standard deviation to a threshold value; and
computing a second plurality of correlation offsets based on a second plurality of sub-regions within the estimated overlapping region.

14. The method of claim 12, wherein computing a plurality of correlation offsets further comprising:
calculating a correlation coefficient for each of the sub-regions;
identifying a maximum correlation; and
computing a correlation offset based on the maximum correlation.

15. The method of claim 14, wherein computing a plurality of correlation offsets further comprising:
determining whether the plurality of correlation offsets are similar; and
computing a second plurality of correlation offsets based on a second plurality of sub-regions within the estimated overlapping region, wherein the plurality of overlapping regions are computed based on the second plurality of correlation offsets.

16. The method of claim 11, further comprising:
performing a median filtering operation on one of the plurality of images;
performing edge detection on the median filtered image to form an edge image;
multiplying the edge image with a corresponding threholded image to form a resultant image, wherein the thresholded image is formed by thresholding the median filtered image;
selecting a plurality of sub-regions within the resultant image; and
compute a plurality of correlation offsets based on plurality of sub-regions.

17. The method of claim 11, wherein the plurality of images comprise a plurality of rows, each row comprising multiple images, and wherein overlapping regions are computed for each image in a first row of the plurality of rows, images within the first row are combined to form a first row image, overlapping regions are computed for each image in a second row of the plurality of rows, the first and second rows being contiguous rows, images within the second row are combined to form a second row image, an overlapping region between the first and the second row images is computed, and the first and the second row images are combined.

18. The method of claim 11, further comprising:
combining the plurality of images based on estimated overlapping regions to form a pre-scan image;
identifying at least one image in which white space occupies a substantial area at a potential overlapping region.

19. A computer-readable storage medium having stored thereon programming for execution on a computing device, wherein the programming causes the computing device to perform operations comprising:
receiving the plurality of images, each of the plurality of images capturing a portion of a plurality portions of an object, each portion of the plurality of portions overlaps a contiguous portion of a specimen, each of the plurality of images overlaps a contiguous image;
computing a plurality of overlapping regions, each overlapping region is computed for each of the plurality of images and a respective contiguous image; and
combining the plurality of images based on the plurality of overlapping regions form the composite image.

20. A system for generating a composite image, comprising:
a plurality of stepper motors configured to:
move a specimen on a plane parallel to an acquisition lens via a plurality of stepper motors; and
move the specimen along a direction orthogonal to the plane parallel to the acquisition lens via one of said plurality of stepper motors;
a subsystem configured to:
position the specimen to acquire an image of a first portion of a plurality portions of the specimen, wherein, each portion of the plurality of portions overlaps a contiguous portion of the specimen;
acquire a plurality of images of the first portion, wherein the each image of the plurality of images is heuristically acquired at a different distance from the acquisition lens by directing at least one of the plurality of stepper motors to move the specimen along a direction orthogonal to the plane parallel to the acquisition lens via one of said plurality of stepper motors;
select an image from the plurality of images in accordance with an optical parameter;
reposition the specimen, performing the acquiring, and performing the selecting of respective images for each of the remaining plurality of portions of the specimen; and
combine the plurality of selected images to form the composite image; and
a communication portion configured to facilitate communication between the plurality of stepper motors and the subsystem.
